(19) United States
(12) Patent Application Publication
(10) Pub. No.: US 2012/0291596 A1
(43) Pub. Date: Nov. 22, 2012

(54) Simple socket

(76) Inventor: Denton L. Jackson, Coldwater, MS (US)

(21) Appl. No.: 13/068,637

(22) Filed: May 17, 2011

(51) Int. Cl. B25B 13/06; B25B 23/10

(52) U.S. Cl. 81/121.1; 81/52

(57) ABSTRACT

A tool, the Simple Socket, which will with the installation of a fastener on or into its intended receiver while also holding another object, most often a washer(s), in axial alignment with the fastener. An elastic sleeve surrounds a fastener driver with a lip extending beyond the fastener. If the fastener is of an internal drive configuration, the tool includes a tube that mounts on the fastener driver and extends over the shank of the driver and the sleeve is axial mounted to the tube. The extended lip of the sleeve retains the washer in axial alignment with the fastener while it is advanced on or into its intended receiver. The driver may accept another tool opposite the fastener to apply torque. The elastic sleeve also provides dielectric insulation surrounding the tool.

### BACKGROUND OF THE INVENTION

The technical field of the invention relates to tools for installing fasteners.

Description of related art. There continues to be a need to install fasteners and various washers and/or other objects to be captured by a fastener while wearing protective gloves. In the power distribution industry lineman work on various components while they are powered or “hot” and there is also the risk of switched out equipment and lines becoming accidentally energized. The risk of electrocution is always present and safety practices require wearing protective gloves that can be cumbersome while trying to thread a nut or bolt with one or more washers on or into its intended receiver. The difficulties are compounded while linemen are working in elevated positions.

### SUMMARY OF THE INVENTION

According to an aspect of the invention, a fastener driver adaptive to the head of an externally driven fastener includes an axial mounted elastic sleeve surrounding the driver and the sleeve having an opening which accepts the fastener and an extended region proximal to the fastener opening slide-ably grips another object most often a washer(s) retaining it axially to the fastener.

According to another aspect of the invention, a fastener driver adaptive to the head of an externally driven fastener includes an axial mounted dielectric elastic sleeve surrounding the driver and the sleeve having an opening which accepts the fastener and an extended region beyond the driver proximal to the fastener opening slide-ably grips another object most often a washer(s).

According to another aspect of the invention, a fastener driver adaptive to the head of an externally driven fastener includes an axial mounted elastic sleeve surrounding the driver and the sleeve having an opening which accepts the fastener and an extended region beyond the driver proximal to the fastener opening slide-ably grips another object most often a washer(s) and the sleeve and the driver accommodating passing the tool's entire length over the intended fastener receiver.

According to another aspect of the invention, a fastener driver adaptive to the head of an internally driven fastener having a collar mounted on the driver whose outside dimension is greater than the outside dimension of the internally driven fastener's head and includes an axially mounted substantially rigid tube extending over the collar and the driver's fastener contact region whose internal diameter slide-ably accommodates the outside diameter of the fastener and an axial mounted elastic sleeve surrounding the tube and the sleeve having an opening which accepts the fastener and an extended region beyond the tube proximal to the fastener slide-ably grips another object most often a washer(s).

According to another aspect of the invention, the fastener drivers cited above also including a region opposite the fastener opening which accepts another tool drive means including common square drive ratchets, hex drive, external drives and others to complete the torque process.

According to another aspect of the invention, the material of the sleeves cited above selected for its dielectric properties.

According to another aspect of the invention, the sleeves cited above having an enlarged outside diameter region having a textured surface accommodating human grip and may have an outer coating having a lower durometer rating.

According to yet another aspect of the invention, the sleeves cited above extended region having a inwardly beveled edge that tends to spread the sleeve open as it is pushed against a surface thereby reducing any tendency to pinch the sleeve between the fastener or washer and the surface surrounding the intended fastener receiver.

### BRIEF DESCRIPTION OF THE DRAWINGS

FIG. 1 shows an exploded view of the Simple Socket and a fastener.

FIG. 2 shows a cutaway view of the Simple Socket and a fastener.

FIG. 3 shows an exploded view of the Simple Socket with an alternative internally driven fastener driver.

FIG. 4 shows a cutaway view of the Simple Socket with a driver for an internally driven fastener.

FIG. 5 shows an end view of the Simple Socket that may be driven with a ratchet.

FIG. 6 shows an end view of fastener driver 2.

FIG. 7 shows an end view of alternate fastener driver 2.

FIG. 8 shows an opposite end view of alternate fastener driver 2

FIG. 9 shows a cutaway view of the Simple Socket wherein sleeve 3 has an inward beveled end.

FIG. 10 shows a cutaway view of the Simple Socket with beveled end 14 having flared against surface 15.

FIG. 11 shows a side view of Simple Socket 1 with enlarged sleeve 3 having a textured surface.

### DETAILED DESCRIPTION

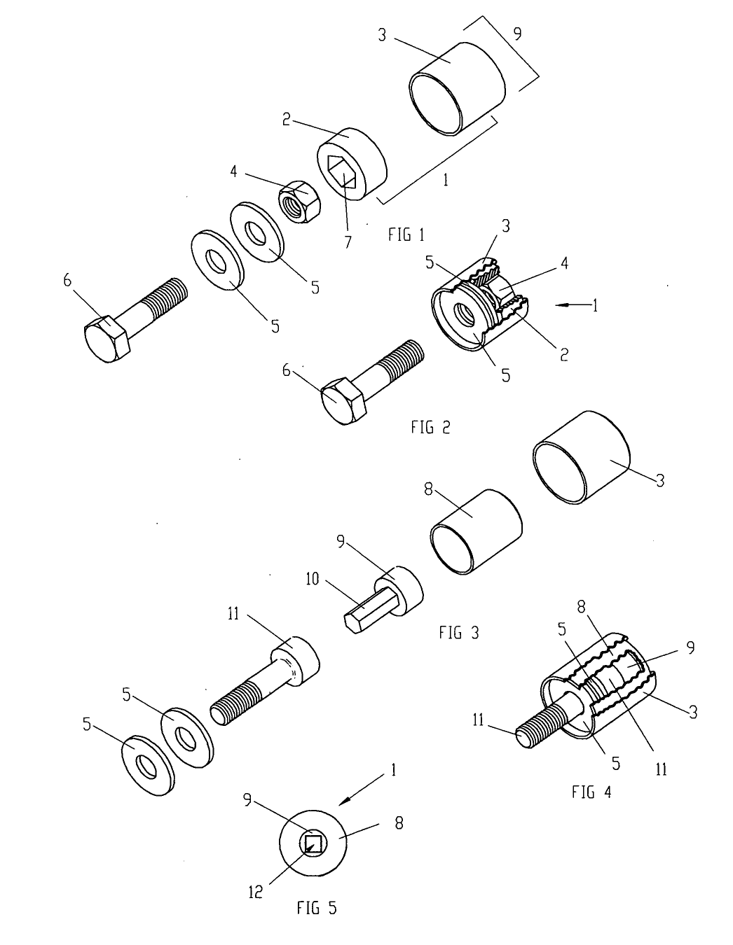

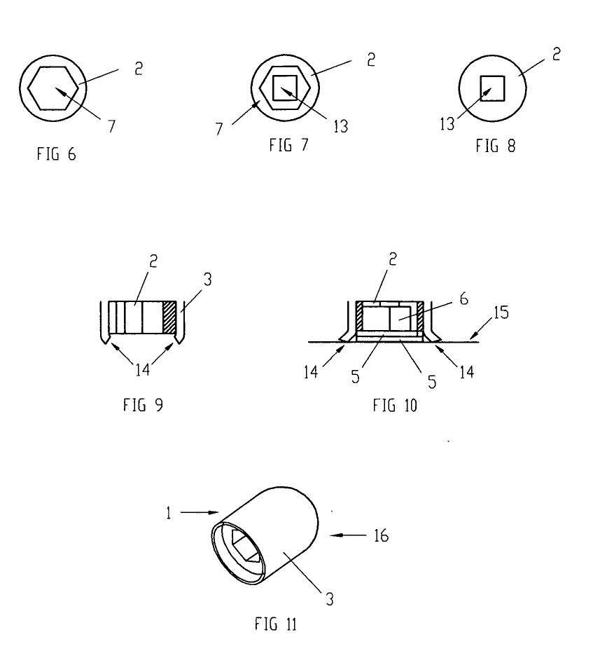

FIG. 1 shows an exploded view of the Simple Socket 1, fastener driver 2, and elastic sleeve 3. Also shown are nut 4 washers 5 and bolt 6. Driver aperture 7 is companionate to the drive surfaces of nut 4 or bolt 6. As shown in cutaway FIG. 2 elastic sleeve 3 is mounted on driver 2 which captures nut 4.

Washers 5 are trapped in the tool by the elastic action of elastic sleeve 3. The tool and fastener are assembled by the user placing the fastener in the driver and then pushing the washers into the elastic sleeve with enough force to overcome its elasticity. The resilience of the elastic sleeve retains the washers. The assembly of the Simple Socket, fastener nut 4 and the washers are then advanced on bolt 6. After the assembly is threaded on bolt 6 the Simple Socket 1 is withdrawn by the user pulling on the tool causing elastic sleeve 3 to flex and to release the tool from the washer(s). The tool will also function to capture a bolt and washers. Driver 2's end opposite the fastener cavity may also be companionate to another tool which would supply torque to complete installation of the fastener before the tool is withdrawn. Especially in applications involving power transmission, the material for elastic sleeve 3 is selected for its dielectric properties.

FIG. 3 shows an exploded view of an alternative embodiment of the Simple Socket 1 in which fastener driver 9 accepts an internally driven fastener 11. Tube 8 is mounted over fastener driver 9 and extends over the driver shank 10 approximately the length of the head of internally driven fastener 11. The outer profile of driver shank 10 is companionate with the internal profile of internally driven fastener 11.

FIG. 4 shows a cutaway view of Simple Socket 1. Fastener 11 is placed on driver shank 10 inside the tool and then washer(s) 5 are placed over the shank of fastener 11 and pushed into elastic sleeve 3. The assembly is then advanced into fastener 11's intended receiver. Driver 9's end opposite shank 10 accepts a drive tool to complete the torque process and then the Simple Socket is pulled off the fastener and washer(s).

FIG. 5 shows an end view of alternate Simple Socket 1 with sleeve 8 surrounding the end. Driver 9's end opposite driver shank 10 is shown and describes a square aperture that will accept a common square drive ratchet but may be of other configurations to accept other tools used to complete fastener torqueing operations. That opposite end of driver 2 may also have an external surface configuration to accept tools which drive with internal surfaces.

FIG. 6 shows an end view of fastener driver 2 with aperture 7. The shank of bolt 6 (shown in FIG. 1) may pass completely through the tool.

FIG. 7 shows an end view of an alternate fastener driver 2 in which the end opposite the fastener entry describes a square aperture 13 which will accept a common square drive ratchet but may be of other configurations to accept tools used to complete fastener torqueing operations. That opposite end of driver 2 may also have an external surface configuration to accept tools which drive with internal surfaces.

FIG. 8 shows an opposite end view of alternate fastener driver 2 and aperture 13.

FIG. 9 shows a cross section view of fastener driver 2 and sleeve 3 having internally beveled end 14. Beveled end 14 tends to spread sleeve 8 open as the sleeve is pressed against a surface.

FIG. 10 shows a cutaway view of fastener driver 2 and sleeve 3, the head of bolt 6 and washers 5 in contact with surface 15 and beveled end 14 having flared against surface 15 thereby preventing pinching of the sleeve between washers 5 and surface 15.

FIG. 11 shows a side view of Simple Socket 1 with enlarged sleeve 3 having a textured surface and enlarged curved region 16 which improves ergonomics for gripping.

### CONCLUSION

The embodiments described and shown are intended to be illustrative and not limiting the claims. Those skilled in the art can envision equivalent alternate embodiments to practice what is taught by this application.

I claim:

1. A tool comprising: a fastener driver adaptive to the head of an externally driven fastener and a dielectric elastic sleeve surrounding and attached to the driver having an end extending a predetermined distance beyond the fastener entry of the driver and that sleeve end having an inwardly beveled edge and tending to constrict radially.

2. The tool of claim 1 wherein, the internal profile of the driver is consistent over its entire length.

3. The tool of claim 1 wherein, the driver end opposite the fastener entry defines an attachment means for another tool.

4. The tool of claim 1 wherein, the driver is a socket.

5. The tool of claim 1 wherein, the dielectric sleeve has an enlarged substantially roundish region opposite the driver fastener opening defining an aperture axial to the driver.

6. The tool of claim 1 wherein, the dielectric sleeve has an enlarged substantially roundish region opposite the driver fastener opening defining an aperture axial to the driver and having a textured surface.

7. The tool of claim 1 wherein, the dielectric sleeve has an enlarged substantially roundish region opposite the driver fastener opening defining an aperture axial to the driver and having a coating of a lower durometer rating with a textured surface.

8. A tool comprising: a fastener driver having a first end adaptive to the head of an internally driven fastener and its second end having a collar whose outer dimensions are larger than the outer dimensions of the head of the fastener and an axial mounted substantially rigid tube mounted on the collar and extending at least the length of the driver's first end and a dielectric elastic sleeve surrounding and attached to the tube having an end extending a predetermined distance beyond the tube and that end having an inwardly beveled edge and tending to constrict radially.

9. The tool of claim 8 wherein, the driver distal end opposite the driver's first end defines an attachment means for another tool.

10. The tool of claim 8 wherein, the driver and collar is a socket.

11. The tool of claim 8 wherein, the dielectric sleeve has an enlarged substantially roundish region opposite the driver's first end defining an aperture axial to the driver.

12. The tool of claim 8 wherein, the dielectric sleeve has an enlarged substantially roundish region opposite the driver fastener opening defining an aperture axial to the driver and having a textured surface.

13. The tool of claim 8 wherein, the dielectric sleeve has an enlarged substantially roundish region opposite the driver fastener opening defining an aperture axial to the driver and having a coating of a lower durometer rating with a textured surface.
